(19) United States
(12) Patent Application Publication
(10) Pub. No.: US 2008/0253383 A1
(43) Pub. Date: Oct. 16, 2008

(54) Communicating using the port-preserving nature of symmetric network address translators

(75) Inventors: Amit Sehgal, Kirkland, WA (US); Kalven Wu, Bellevue, WA (US); Xinyan Zan, Issaquah, WA (US); Neeraj Garg, Bellevue, WA (US)

Correspondence Address: WOLF GREENFIELD (Microsoft Corporation);C/O WOLF, GREENFIELD & SACKS, P.C., 600 ATLANTIC AVENUE, BOSTON, MA, 02210-2206, US

(73) Assignee: Microsoft Corporation, Redmond, WA (US)

(21) Appl. No.: 11/786,989

(22) Filed: Apr. 13, 2007

(51) Int. Cl. H04L 12/66

(52) U.S. Cl. 370/401

(57) ABSTRACT

Methods for establishing connections between computing devices when the computing devices are behind Network Address Translators (NATs). Embodiments of the present invention are directed to enabling a first client computer to communicate with a second client computer when both client computers are positioned behind NATs, wherein at least one of the NATs is a port-preserving NAT.

### BACKGROUND OF THE INVENTION

Computer networks allow computers and potentially any associated users to communicate electronically throughout the globe over a worldwide amalgamation of networks often referred to as the Internet. A common network protocol used to communicate over the Internet is called the Internet Protocol or “IP.” There are a number of different versions of IP including the common IP version 4 (herein also referred to as “IPv4”) and the more recently-developed IP version 6 (herein also referred to as “IPv6”). Although IP is used on the Internet, it can be used in a variety of network contexts. IP is also often employed within local networks to connect computers.

In order for one computing system to communicate with another computing system over a particular network, it is important that each computing system be uniquely identified on that network. IPv4 provides a 32-bit addressing mechanism, which should allow for 2³² or approximately 4 billion different addresses. Practical considerations limit the number of IPv4 addresses to approximately 2 or 3 billion. While this may seem like an unlimited supply of addresses, the proliferation of the Internet and network devices throughout the globe has pushed or exceeded these address limits.

As the pool of available IPv4 addresses has shrunk, various systems have developed to allow multiple computers or devices to share a single external (i.e., directly accessible from the Internet) IP address. One such system is called “Network Address Translation.” A Network Address Translation device (also known as a “Network Address Translator” or a “NAT”) separates a number of computing systems in a private network from the rest of the Internet. All computing devices connected to the Internet that are not behind a NAT are required to have an IP address that is unique to all other Internet-connected computing devices. (As used herein, a computing device that is described as “behind a NAT” is one that is on the private network side of the NAT.) The computing systems in each private network, however, generally have an address that is unique to that private network, but not necessarily to the global Internet. The NAT then translates that private address into a globally unique IP address on the fly as each packet exits the private network through the NAT and into the global Internet. NATs typically alter packets using Transmission Control Protocol (TCP) and User Datagram Protocol (UDP) port mapping to enable two-way traffic between external hosts and internal clients.

Accordingly, the NAT uses a limited number (potentially just one) of globally unique addresses that it exposes to the Internet, while allowing the network devices that are behind the NAT to have a larger number of private network addresses that need not be globally unique throughout the Internet. The use of NATs therefore provides a short term solution to the problem of there being a relatively limited number of IPv4 addresses available. Accordingly, IPv4 computing systems and NATs often work together.

Certain address blocks are reserved under IPv4 for NAT-internal use only. For example, the address blocks 10.0.0.0/8, 192.168.0.0/16, 172.16.0.0/12 are all defined in RFC 1918 (entitled “Address Allocation for Private Internets”) as reserved for “Private Internets.” Generally, a NAT device routes packets to and from a reserved “private” IP address to a world-accessible “public” IP address.

IPv6, on the other hand, has a 128-bit addressing mechanism, which is sufficient to provide unique addresses for well into the anticipated future. Accordingly, the problem associated with a limited number of unique addresses under IPv4 may be addressed by reconfiguring the Internet to operate exclusively under IPv6 instead. Such a reconfiguration will likely occur over an extended period of time because there is significant infrastructural investment in the current Internet that is based on the IPv4 protocol. Furthermore, there is no one governing entity that controls the entire Internet. Accordingly, it is commonly accepted that the Internet needs to concurrently work with both IPv6 and IPv4, at least for the near future. In order to facilitate robust communication over the Internet, mechanisms have been developed that allow for IPv4 computing systems to communicate with IPv6 computing systems.

One mechanism often referred to as the “6to4” mechanism uses IPv6 packets as payload of IPv4 packets. When transitioning from an IPv4 network to an IPv6 network, the IPv6 packet is extracted and transmitted. When transitioning from an IPv6 network to an IPv4 network, the IPv6 packet is included as the payload of an IPv4 packet, and then the IPv4 packet is transmitted. Several problems exist with this 6to4 mechanism. Specifically, it may not work well when the IPv4 computing system that is to communicate is behind a NAT. Many NATs are not programmed to allow the transmission of arbitrary payload types. Accordingly, NATs may not permit communication of a payload in the form of an IPv6 packet. Even when the NAT permits such communication, the local address within the private network cannot be used in a 6to4 scheme.

“Teredo” is another protocol for transporting packets between nodes that support only IPv4 and nodes that support IPv6. Teredo is described in more detail in RFC 4380 (entitled “Teredo: Tunneling IPv6 over UDP through Network Address Translations (NATs)”). Teredo encapsulates IPv6 packets within IPv4 UDP datagrams, which most NATs can forward properly. Thus, IPv6-aware hosts behind NATs can be used as Teredo tunnel endpoints even when they don't have a dedicated public IPv4 address.

The Teredo implementation usually involves a client, a relay, and a server, although a relay is not always necessary. The Teredo client is a device on an IPv6 network. The client is assigned a unique IPv6 address that starts with a specific reserved prefix (2001:0000::/32).

A Teredo relay connects clients on an IPv6 network with an IPv4 network. The relay advertises a route to the Teredo IPv6 prefix to other IPv6 hosts in order to receive traffic from those hosts addressed to any Teredo client. The relay then forwards received packets as a UDP datagram within an IPv4 packet. The relay also receives packets from Teredo clients addressed to native IPv6 hosts over UDP/IPv4 and forwards those packets into the native IPv6 network.

A Teredo server is used by a Teredo client both to determine whether the client is behind a NAT (and if so, to determine the type of NAT), and also to “punch holes” in the NAT so that the NAT will allow incoming traffic and forward it to the correct client. “Hole punching” involves initiating a connection from a host behind a NAT to a host external to the NAT so that the NAT will subsequently forward packets received from that external host back to the internal host. Some of the various types of NATs are described below.

A NAT needs to transmit packets both from an internal client to the external destination and in the opposite direction to facilitate communication. Accordingly, it needs some way to identify and match packets received from the outside with specific internal hosts. This is generally accomplished using port mapping. Port mapping can either be manually configured on the NAT, or can occur automatically. There are several different types of NATs that are commonly in use that can be categorized in terms of the system they use for port mapping. These definitions are set out in RFC 3489 (entitled “STUN—Simple Traversal of User Datagram Protocol (UDP) Through Network Address Translators (NATs)”).

In the case of a “full cone” NAT, also known as “one-to-one” NAT, all requests that originate from the same internal IP address and port are mapped to the same external IP address and port. An external host can send a packet to the internal host by sending a packet to the mapped external address. For example, if the internal client has a local IP address of 192.168.1.5, and it attempts to connect to a web server on the Internet operating on port 80, the full cone NAT could modify the packet so the source IP address is the external IP address of the NAT device, for example, 151.207.245.67, and the source port could be mapped, usually to some unprivileged port, for example, 2000.

A “restricted cone” NAT is similar to a “full cone” NAT inasmuch as all internal requests from the same host to the same port number are mapped to the same external IP address and source port. Restricted cone NATs have the additional limitation that only external systems that have previously been sent packets are permitted to connect to the internal system. Thus, before an external system can connect to a client within the NAT, the client must have first initiated communication with that external system.

A “port-restricted cone” NAT is similar to a “restricted cone” NAT with the additional limitation that external systems can only connect to clients within the NAT on the same port that the internal client used to connect to the external system.

An “address-symmetric” NAT uses different external port mappings for outgoing packets to different remote endpoints, even when they originate from the same internal port mapping. The external port mapping differs both in the source IP address and source port. Furthermore, an address symmetric NAT permits incoming packets only from those remote endpoints (for both address and port) to which it has recently sent outgoing packets.

A “port-symmetric” NAT is similar to an address-symmetric NAT, except that the external mapping differs only in the source port but not the source IP address. For the purposes of this application, a “symmetric” NAT is a port-symmetric NAT. Accordingly, when a host is behind a symmetric NAT, only external hosts that have received packets from the internal host can send a packet back to the internal host.

For the purposes of this application, a “restricted” NAT is any NAT other than a full cone NAT.

Typically, port mappings established from outgoing packets expire after some period of time when there is no data flow in either direction over those port mappings.

### SUMMARY OF THE INVENTION

Embodiments of the present invention are directed to enabling a first client computer to communicate with a second client computer when both client computers are positioned behind Network Address Translators (NATs), wherein at least one of the NATs is a port-preserving symmetric NAT.

In one embodiment, there is provided a method for communicating between first and second computing devices wherein each computing device is behind a Network Address Translator (NAT). The method comprises transmitting a first communication from the first computing device to a third computing device adapted to relay communications from the first computing device to the second computing device, the third computing device having an existing connection to both the first computing device and the second computing device. The first communication comprises an indicator of a port number on the first computing device over which the first and second computing devices are to communicate. The method further comprises transmitting a second communication from the first computing device to the second computing device to open a connection, wherein an originating address of the second communication has a port number equivalent to the port number contained in the indicator.

In another embodiment, there is provided a method for communicating between first and second computing devices wherein each computing device is behind a Network Address Translator (NAT). The method comprises receiving a first communication at the second computing device from a third computing device adapted to relay communications from the first computing device to the second computing device, the third computing device having an existing connection to both the first and second computing devices. The first communication comprises an indicator of a port number on the first computing device over which the first and second computing devices are to communicate. The method further comprises transmitting, from the second computing device to the first computing device, a second communication, wherein a destination address of the second communication has a port number equivalent to the port number contained in the indicator, and receiving, at the second computing device from the first computing device, a third communication to open a connection. An originating address of the third communication has a port number equivalent to the port number contained in the indicator.

In a further embodiment, there is provided a computer apparatus comprising at least one computer-readable medium, the computer-readable medium having computer-executable instructions encoded thereon which, when executed, cause the computer apparatus to execute a method for communicating between first and second computing devices wherein each computing device is behind a Network Address Translator (NAT). The method comprises transmitting a first communication from the first computing device to a third computing device adapted to relay communications from the first computing device to the second computing device, the third computing device having an existing connection to both the first computing device and the second computing device. The first communication comprises an indicator of a port number on the first computing device over which the first and second computing devices are to communicate. The method further comprises transmitting a second communication from the first computing device to the second computing device to open a connection, wherein an originating address of the second communication has a port number equivalent to the port number contained in the indicator.

### BRIEF DESCRIPTION OF THE DRAWINGS

In the drawings:

FIG. 1 shows a simplified, illustrative network wherein two clients are attempting to communicate from behind NATs and are precluded from doing so by NAT policies;

FIG. 2 depicts a Teredo client that is connected to the IPv4 Internet through a NAT device sending a packet to a Teredo server;

FIG. 3 depicts a Teredo server sending a message through the IPv4 Internet back to a Teredo client through a NAT device;

FIG. 4 shows an illustrative process for enabling communication between computing devices behind NATs in accordance with some embodiments of the invention, wherein the NATs are both port-preserving symmetric NATs;

FIG. 5 shows an illustrative process for enabling communication between computing devices behind NATs in accordance with some embodiments of the invention, wherein one computing device is behind a port-restricted NAT and one computing device is behind a port-preserving symmetric NAT;

FIG. 6 shows an illustrative process for enabling communication between computing devices behind NATs in accordance with some embodiments of the invention, wherein one computing device is behind a port-preserving symmetric NAT and one computing device is behind a port-restricted NAT;

FIG. 7 shows an illustrative process for enabling communication between computing devices behind NATs in accordance with some embodiments of the invention, wherein one computing device is behind an address-restricted NAT and one computing device is behind a port-preserving symmetric NAT;

FIG. 8 shows an illustrative process for enabling communication between computing devices behind NATs in accordance with some embodiments of the invention, wherein one computing device is behind an address-restricted NAT and one computing device is behind a port-preserving symmetric NAT;

FIG. 9 shows an illustrative process for enabling communication between computing devices behind NATs in accordance with some embodiments of the invention, wherein one computing device is behind a port-preserving symmetric NAT and one computing device is behind an address-restricted NAT; and

FIG. 10 depicts an exemplary general-purpose computing system in accordance with some embodiments of the invention.

### DETAILED DESCRIPTION

Applicants have appreciated that communication between computing devices behind Network Address Translators (NATs) may be disrupted or precluded if the NATs are restricted NATs and/or symmetric NATs. This may be a result of the symmetric and restricted NATs' policies, described above, of preventing a computing device on the “public” side of the NAT from communicating with a computing device on the “private” side of the NAT if the private-side device has not previously or recently communicated with the public-side device.

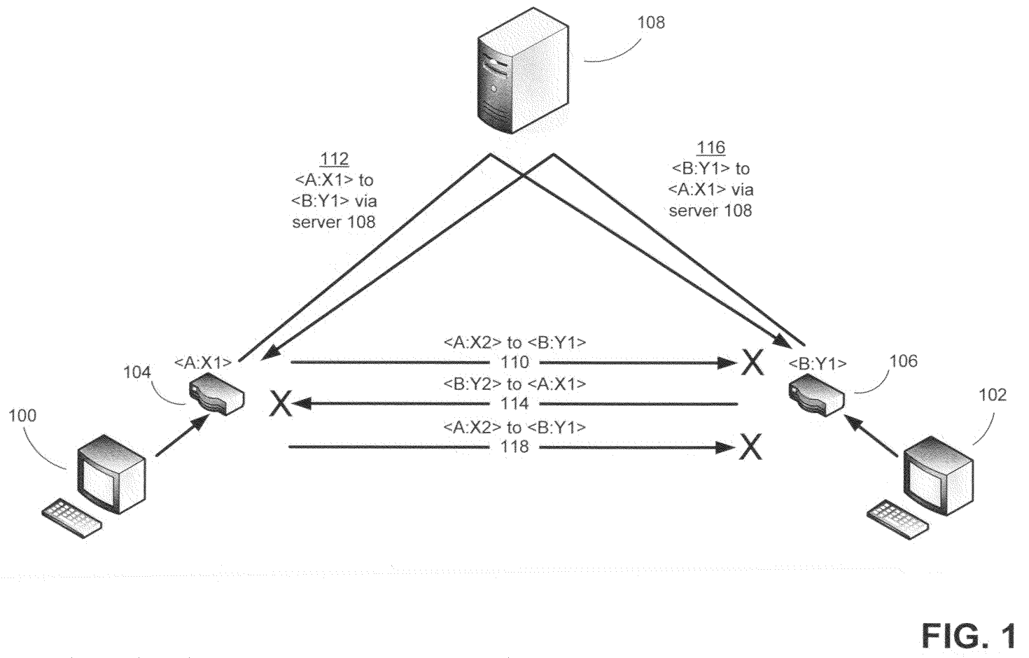

FIG. 1 shows a simplified, illustrative network wherein two clients are attempting to communicate from behind symmetric NATs and are precluded from doing so by the above-described policies. The illustrative network comprises computing devices 100 and 102 behind NATs 104 and 106, respectively. As shown, computing device 100 has had its private IP address and port number for a particular service mapped to a public IP address and port number represented by address <A:X1>, while the private IP address and port number of computing device 102 for a particular service have been mapped to address <B:Y1>.

In accordance with one embodiment of the invention, computing devices 100 and 102 may be implemented as Teredo clients, and the network may further comprise a Teredo server 108. In a Teredo system, a Teredo client may connect to the Teredo server when it initially connects to the network and thereby inform the Teredo server of its public IP address and port number for the Teredo service (e.g., address <A:X1> or address <B:Y1>). The Teredo server may then provide that information to other Teredo clients seeking to communicate with the new client.

Computing device 100, having been provided with the public IP address and port number of computing device 102 either by the server 108 or in any other suitable manner, attempts to open a connection to computing device 102 in transmission 110 with a transmission directly to address <B:Y1>. This transmission may be in any suitable form. For example, the transmission may comprise a single packet or multiple packets, or may comprise a single or multiple datagram(s). For simplicity, as used herein “packet” will refer to any suitable transmission of data and/or instructions of any size or fragmentation unless stated otherwise.

This packet is transmitted from the public address <A:X2> because the NAT 104 detects that the computing device 100 has not previously or recently communicated with computing device 102. According to the policies of the NAT 106, the packet is blocked because computing device 102 has not previously or recently communicated with computing device 100 to address <B:Y1>. Computing device 100, upon detecting that this packet was blocked by either recognizing than an acknowledgement was not received or in any other suitable manner, sends a second packet to computing device 102 via server 108 in transmission 112. This packet is transmitted to address <A:X1> because the NAT 104 detects that it is being transmitted to server 108, to which it had previously communicated to address <A:X1>. This information is relayed to computing device 102 and is not blocked by NAT 106 because the NAT 106 detects that computing device 102 had previously and recently communicated with server 108 to address <B:Y1>.

Prior to transmission 114, computing device 102 processes the packet received from computing device 100 via server 108 and attempts to initiate communication with computing device 100. A packet is transmitted to address <A:X1> in transmission 114, the address contained in the information received from server 108, and is transmitted from the public address <B:Y2> because the NAT 106 detects that the computing device 102 has not previously or recently communicated with computing device 100. This packet is blocked by NAT 104 because computing device 100 has not previously or recently communicated with computing device 102 to address <B:Y2>. Computing device 102, upon detecting that this packet was blocked by recognizing than an acknowledgement was not received or detecting in any other suitable manner, sends a second packet to computing device 100 indirectly via server 108 in transmission 116. This packet is transmitted to address <B:Y1> because the NAT 106 detects that it is being transmitted to server 108, to which it had previously communicated to address <B:Y1>. This packet is relayed to computing device 102 and is not blocked by NAT 106 because the NAT 106 detects that computing device 102 had previously and recently communicated with server 108 to address <A:X1>.

The packet of transmission 116 is then processed by computing device 100, which attempts to communicate with computing device 102. A packet is transmitted to public address <B:Y1>—the address contained in the packet from server 108—and is transmitted from public address <A:X2> because the NAT 104 detects that computing device 100 had previously tried to communicate with address <B:Y1> to address <A:X2>. This packet is blocked just as the packet of transmission 110 was, and the process repeats. There is no way for the computing devices to communicate from behind the NATs.

As stated above, Applicants have appreciated the existence of this problem when computing devices are behind a port-restricted or symmetric NAT.

In view of the foregoing, one embodiment of the present invention is directed to enabling communication between computing devices when at least one device is behind a port-restricted or symmetric NAT.

It should be appreciated that while FIG. 1 illustrates the clients as Teredo clients and includes a Teredo server, embodiments of the invention are not limited to implementing or being implemented with the Teredo protocol as any suitable protocol for exchanging data and instructions between two computing devices may be implemented in accordance with embodiments of the invention.

In one embodiment of the invention, the port-preserving nature of a symmetric or port-restricted NAT is used to enable communication. A port-preserving NAT is one which always chooses the internal/private port number as the external/public port for a connection if the port is not already in use. There are several ways in which a computing device may determine whether the NAT it is behind is a port-preserving NAT. An exemplary method making use of Teredo is now described along with some background information on the Teredo protocol.

As mentioned above, a computing device operating as a Teredo client may connect to a Teredo server upon being connected to a network. One reason for this may be to determine its full Teredo IPv6 address. Because a NAT translates the source IP address and the source port as it forwards packets from the internal host, the Teredo server will receive the request as appearing to originate from the translated address. It can then respond to the Teredo client with the information that the client needs to construct its complete IPv6 address.

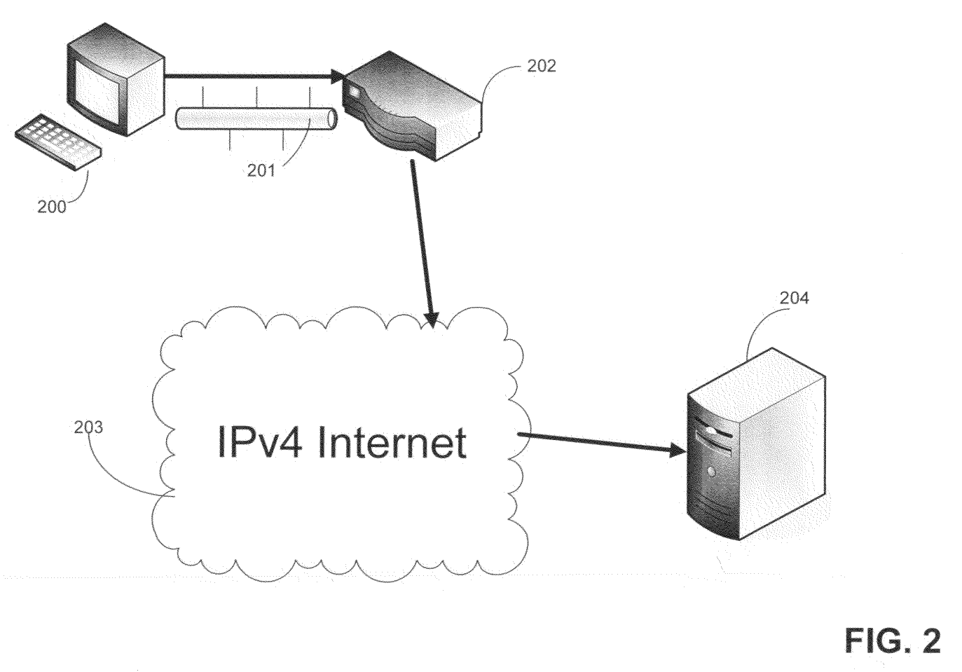

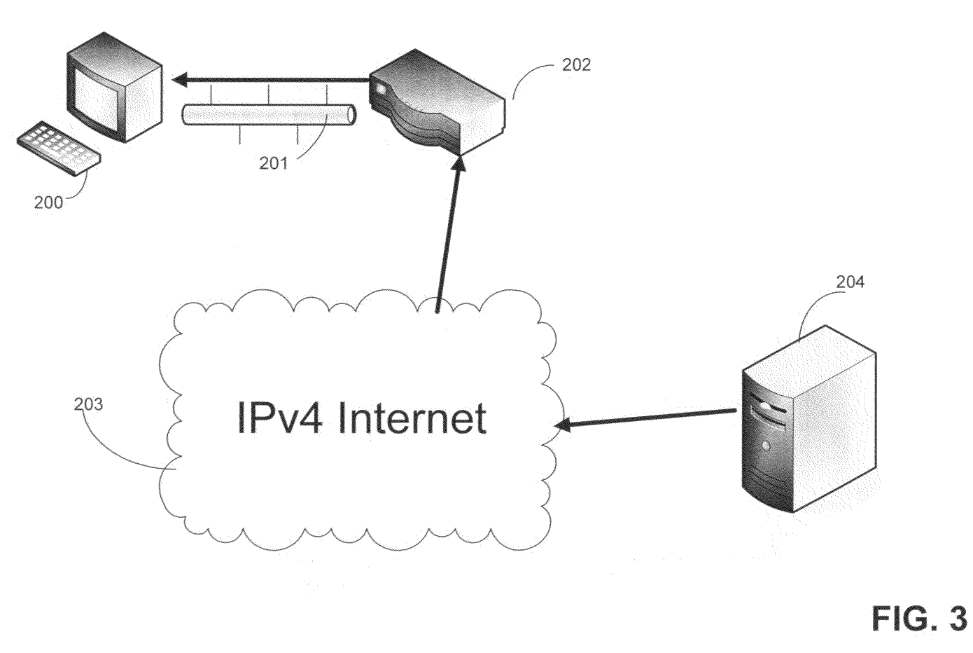

An example of the process of Teredo IPv6 address detection is illustrated in FIG. 2 and FIG. 3. In FIG. 2, the Teredo client 200 sends an IPv4 packet to a Teredo server 204. The client 200 is connected to a NAT 202 through an Ethernet connection 201. In some embodiments, a UDP packet is sent to a port on the Teredo server 204 (e.g., port 3544) for the purpose of address detection. In some embodiments, this packet is called a “Router Solicitation” (or RS) message. One implementation of the Router Solicitation message is described in RFC 2461 (entitled “Neighbor Discovery for IP Version 6 (IPv6)”). The packet is sent from the client 200 to the NAT 202 through the Ethernet connection 201, at which point the NAT 202 modifies the source IP address to be the external IPv4 address of the NAT 202. The NAT 202 also modifies the source port and adds the new source port to a routing table so that later-received incoming packets will be properly forwarded back to the internal client 200. The NAT 202 then forwards the packet to the Teredo server 204 through the IPv4 Internet 203.

As shown in FIG. 3, the Teredo server 204 then sends a return packet back to the internal client 200, again through the IPv4 Internet 203. The return packet includes information that can be processed by the internal client 200 to determine the external IP address of the NAT 202 as well as the source port of packets that were forwarded from the internal client 200 to the server 204 through the NAT 202. In some embodiments, the packet is called a “Router Advertisement” (or RA) message, also defined in RFC 2461. When the return packet arrives at the NAT 202, the NAT forwards the packet to the client 200 on the basis of the destination port. Once this process is complete, the internal client 200 will have all the information it needs to form a synthetic Teredo IPv6 address, as shown in FIG. 1. That synthetic address can then serve as a mechanism for reaching the internal client 200 from the IPv6 Internet and vice-versa.

In addition to informing the client 200 of its external IP address and source port, the Teredo server 204 can be used by the client 200 in some embodiments to determine the type of NAT 202 that the client 200 is behind. In one embodiment, the server 204 has two distinct IPv4 addresses. In another embodiment, two different servers, each with its own IPv4 address, can also be used by the client 200 to detect the type of NAT 202 it is behind. Once the server 204 receives the initial packet from the client 200, the server 204 can attempt to reach the client 200 using a different source IPv4 address than the destination IPv4 address of the initial request from the client 200. If the packet from the different IPv4 address successfully reaches the client 200, then the client 200 can assume that all traffic to its source port will be forwarded by the NAT 202, regardless of the origin IP address. The client 200 can conclude that the NAT 202 is a full cone NAT, and set the flags 121 in its Teredo address accordingly. If the return packet does not arrive, then the NAT 202 may be a port- or address-restricted NAT, or a symmetric NAT, in which case external hosts will not be able to reach the internal client 200 without additional measures described in more detail below.

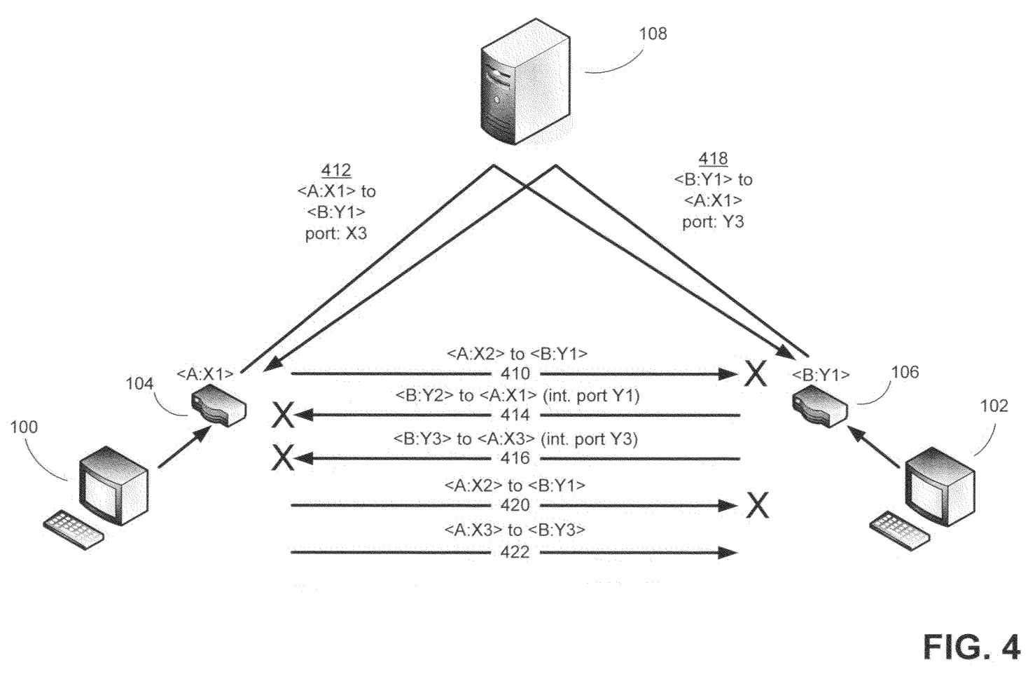

The process followed by embodiments of the invention to enable communication may best be understood in the context of exemplary implementations. FIG. 4 shows an illustrative process for enabling communication between computing devices behind NATs in accordance with some embodiments of the invention. FIG. 4 shows, similar to FIG. 1, two computing devices 100 and 102 behind two NATs, 104 and 106, respectively. Computing devices 100 and 102 may be, in some embodiments of the invention, Teredo clients. FIG. 4 further shows a server 108 which may be, in some embodiments of the invention, a Teredo server. In the exemplary network of FIG. 4, both NAT 104 and 106 are port-preserving symmetric NATs. At the start of the process, both computing devices know that they are behind port-preserving NATs either by the process described above or in any other suitable manner, but may not know the type of NAT that the other is behind, or even that the other device is behind a NAT.

In transmission 410, computing device 100 attempts to open a connection to computing device 102 with a packet directly transmitted to computing device 102 from public address <A:X2> to address <B:Y1>. The packet comes from private/internal port X1, but is mapped to address <A:X2> because the NAT 104 may detect that the computing device 100 already has a connection open on private/internal port X1 to server 108 (for reasons discussed above). Thus, the outgoing transmission is mapped to address <A:X2> to be sent to address <B:Y1>. As shown by the “X” in FIG. 4, the packet is blocked by the NAT 106 because it detects that computing device 102 has not communicated with computing device 100 to address <A:X2> previously or recently.

Computing device 100 also opens a new socket locally on a random private port X3, but may not transmit any data over the socket at the time the socket is opened. Computing device 100 indirectly transmits a second packet to computing device 102 through server 108 in transmission 412. Transmission 412 may be initiated once the computing device 100 detects that the transmission of transmission 410 did not reach computing device 102, or at any suitable time. The packet transmitted in transmission 412 includes an indicator of the newly-opened socket on private port X3. This indicator may take any suitable form and may be, for example, a portion of the packet's data payload. The second packet is received by computing device 102 because the NAT 106 detects it as arriving from server 108, to which computing device 102 already has an open connection. When computing device 102 processes the packet from server 108, it also creates a new socket and binds it to a random private port (e.g., Y3).

In transmission 414, computing device 102 transmits a packet to computing device 100 which is sent out from public address <B:Y2> with address <A:X1> as the destination. This packet may be transmitted from internal/private port Y1, but mapped to address <B:Y2> because the NAT 106 detects that the connection on address <B:Y1> is open to server 108. As described above, this packet is blocked by the NAT 104 for the reasons described above.

In transmission 416, computing device 102 sends a second packet to computing device 100 from the new randomly-picked private port Y3. The packet of transmission 416 may also include an indicator of what private port it was transmitted from, to distinguish it from the packet of transmission 414. Because the NAT 106 is port-preserving, the packet is transmitted with a public address <B:Y3>. The second packet is sent to address <A:X3>, in accordance with the packet received from computing device 100 by way of server 108 in transmission 412. This packet is blocked by the NAT 104 because the computing device 100 has not previously or recently communicated with computing device 102 via address <B:Y3>, as described above. In transmission 418, computing device 102 transmits an indirect packet to computing device 100 via server 108 containing an indicator that it is awaiting a connection at port Y3.

In transmissions 420 and 422, computing device 100 responds to the packet 418 by transmitting two packets. The first, in transmission 420, is sent from address <A:X2> to address <B:Y1> in accordance with the information the computing device 100 previously had about computing device 102 (either from the server 108 such as in a Teredo system or from another suitable source). This packet is, as described previously, blocked per the policy of NAT 106 policy. In transmission 422, however, computing device 100 opens a new connection from the randomly-picked port X3 to the port Y3 contained in the packet received from computing device 102 via server 108 in transmission 418. Because the NAT 104 is port-preserving, the external connection is assigned to address <A:X3> and, because computing device 102 had communicated to address <B:Y3> to address <A:X3> previously (in transmission 416), NAT 106 allows the packet transmitted from address <A:X3> to address <B:Y3>, and all subsequent packets on this connection, to pass through to computing device 102.

In this manner, communication has been enabled between two computing devices behind port-preserving symmetric NATs by using the port-preserving functionality of these NATs. As will be further discussed below, however, it should be appreciated that embodiments of the invention may transmit a greater or fewer number of packets based on, for example, the types of NATs the computing devices are behind. Additionally, it should be appreciated that in some embodiments of the invention a generic algorithm may be implemented to execute all transmissions regardless of network properties while in alternate embodiments of the invention a specific algorithm may be implemented to select the transmissions based on the network properties (e.g., type of NATs).

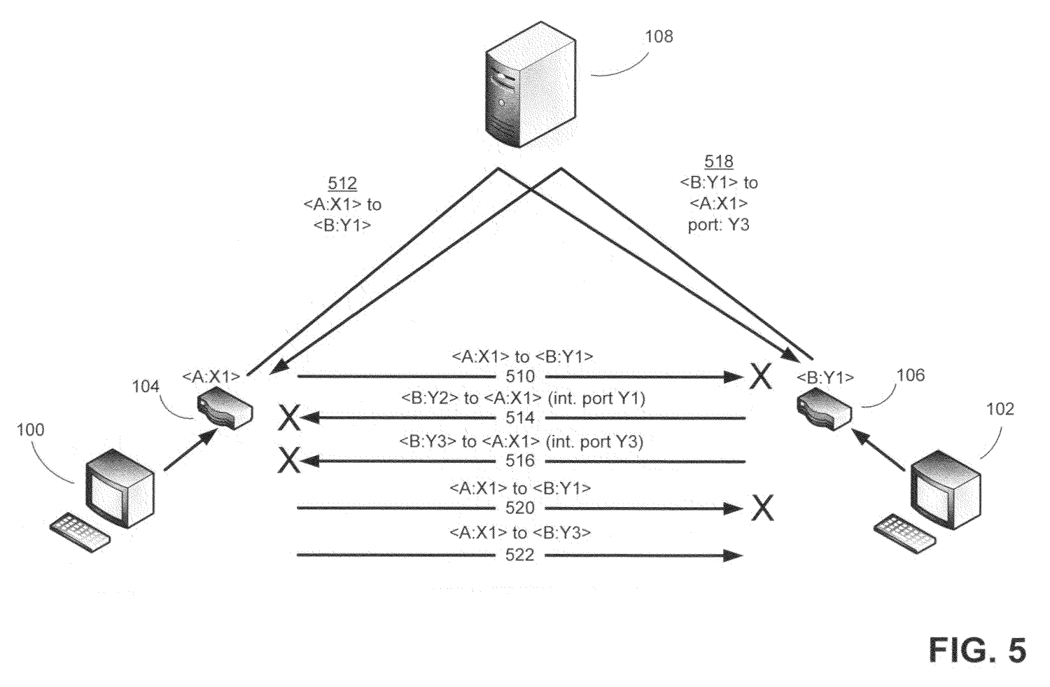

FIG. 5 shows an illustrative process for enabling communication between computing devices behind NATs in accordance with some embodiments of the invention. In this example, computing device 100 is behind a port-restricted NAT and computing device 102 is behind a port-preserving symmetric NAT.

In transmission 510, computing device 100 attempts to open a connection to computing device 102 with a packet transmitted from public address <A:X1> to address <B:Y1>, which is blocked as described above. This packet is transmitted from address <A:X1> because of the nature of NAT 104 as a port-restricted NAT. Detecting that the transmission of transmission 510 did not reach computing device 102, computing device 1100 transmits a packet to computing device 102 through server 108 in transmission 512. This second packet is received by computing device 102 because the NAT 106 detects it as arriving from server 108. When computing device 102 processes the packet from server 108, it creates a new socket and binds it to a random private port (e.g., Y3).

In transmission 514, computing device 102 transmits a packet to computing device 100 which is sent out from public address <B:Y2> with address <A:X1> as the destination. As before, this packet is transmitted from internal/private port Y1. In transmission 516, computing device 102 sends a second packet to computing device 100 from the new randomly-picked private port Y3. The packet of transmission 516 may also include an indicator of what private port it was transmitted from, to distinguish it from the packet of transmission 514. Because the NAT 106 is port-preserving, the packet is transmitted with a public address of address <B:Y3>. The second packet is sent to address <A:X1>, in accordance with the packet received from computing device 100 by way of server 108 in transmission 512. This packet is blocked by the NAT 104 because the computing device 100 has not previously or recently communicated with computing device 102 via address <B:Y3>. In transmission 518, computing device 102 transmits an indirect packet to computing device 100 via server 108 containing an indicator that it is awaiting a connection at port Y3.

In transmissions 520 and 522, computing device 100 responds to the packet 418 by transmitting two packets. The first, in transmission 520, is sent from address <A:X1> to address <B:Y1> in accordance with the information the computing device 100 previously had about computing device 102 (either from the server 108 such as in a Teredo system or from another suitable source). This packet is, as described previously, blocked per the policy of NAT 106. In transmission 522, however, computing device 100 opens a new connection to the port Y3 contained in the packet received from computing device 102 via server 108. Because computing device 102 had communicated to address <B:Y3> to address <A:X1> previously (in transmission 516), NAT 106 allows the packet from address <A:X1> to address <B:Y3>, and all subsequent packets on this connection, to pass through it to computing device 102.

In this manner, communication has been enabled between two computing devices behind a port-preserving symmetric NAT and a port-restricted NAT. As discussed above and as will be further discussed below, however, it should be appreciated that embodiments of the invention may transmit a greater or fewer number of packets based on, for example, the types of NATs the computing devices are behind. Additionally, it should be appreciated that in some embodiments of the invention a generic algorithm may be implemented to execute all transmissions regardless of network properties while in alternate embodiments of the invention a specific algorithm may be implemented to select the transmissions based on the network properties (e.g., type of NATs).

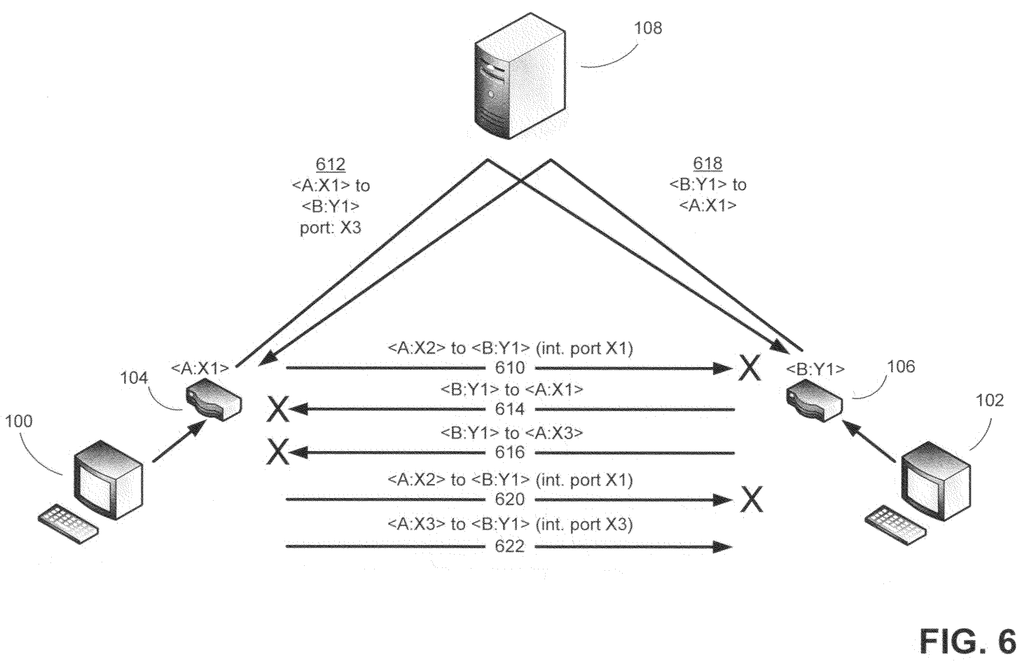

FIG. 6 shows an illustrative process for enabling communication between computing devices behind NATs in accordance with some embodiments of the invention. In this example, computing device 100 is behind a port-preserving symmetric NAT and computing device 102 is behind a port-restricted NAT.

In transmission 610, computing device 100 attempts to open a connection to computing device 102 with a packet transmitted from public address <A:X2> to address <B:Y1>, which is blocked as described above. This packet is transmitted from address <A:X2> because of the nature of NAT 104 as a symmetric NAT (computing device 100 already has a connection on X1 open to the Teredo server). Computing device 100 also opens a new socket locally on a random private port X3, but does not transmit any data over it yet. Detecting that the transmission of transmission 610 did not reach computing device 102, computing device 100 transmits a packet to computing device 102 through server 108 in transmission 612. This packet includes an indicator of the newly-opened socket on private port X3. This second packet is received by computing device 102 because the NAT 106 detects it as arriving from server 108.

When computing device 102 processes the packet from server 108, it transmits a packet (in transmission 614) to computing device 100 which is sent out from public address <B:Y1> with address <A:X1> as the destination. This packet is transmitted from internal/private port Y1 and external/public port Y1 because the NAT 106 is a port-restricted NAT. In transmission 616, computing device 102 sends a second packet to computing device 100 to address <A:X3>, in accordance with the packet received from computing device 100 by way of server 108 in transmission 612. This packet is blocked by the NAT 104 because the computing device 100 has not previously or recently communicated with computing device 102 via address <A:X3>. In transmission 618, computing device 102 transmits an indirect packet to computing device 100 via server 108 indicating that it is attempting to connect.

In transmissions 620 and 622, computing device 100 responds to the packet 618 by transmitting two packets. The first, in transmission 620, is sent from address <A:X2> to address <B:Y1>. This packet is, as described previously, blocked per the policy of NAT 106. In transmission 622, however, computing device 100 opens a new connection on the port X3 randomly-selected earlier and transmitted to computing device 102 via server 108. Because computing device 102 had communicated to address <B:Y1> to address <A:X3> previously (in transmission 616), NAT 106 allows the packet from address <A:X3> to address <B:Y1>, and all subsequent packets on this connection, to pass through it to computing device 102.

In this manner, communication has been enabled between two computing devices behind a port-preserving symmetric NAT and a port-restricted NAT. As discussed above and as will be further discussed below, however, it should be appreciated that embodiments of the invention may transmit a greater or fewer number of packets based on, for example, the types of NATs the computing devices are behind. Additionally, it should be appreciated that in some embodiments of the invention a generic algorithm may be implemented to execute all transmissions regardless of network properties while in alternate embodiments of the invention a specific algorithm may be implemented to select the transmissions based on the network properties (e.g., type of NATs).

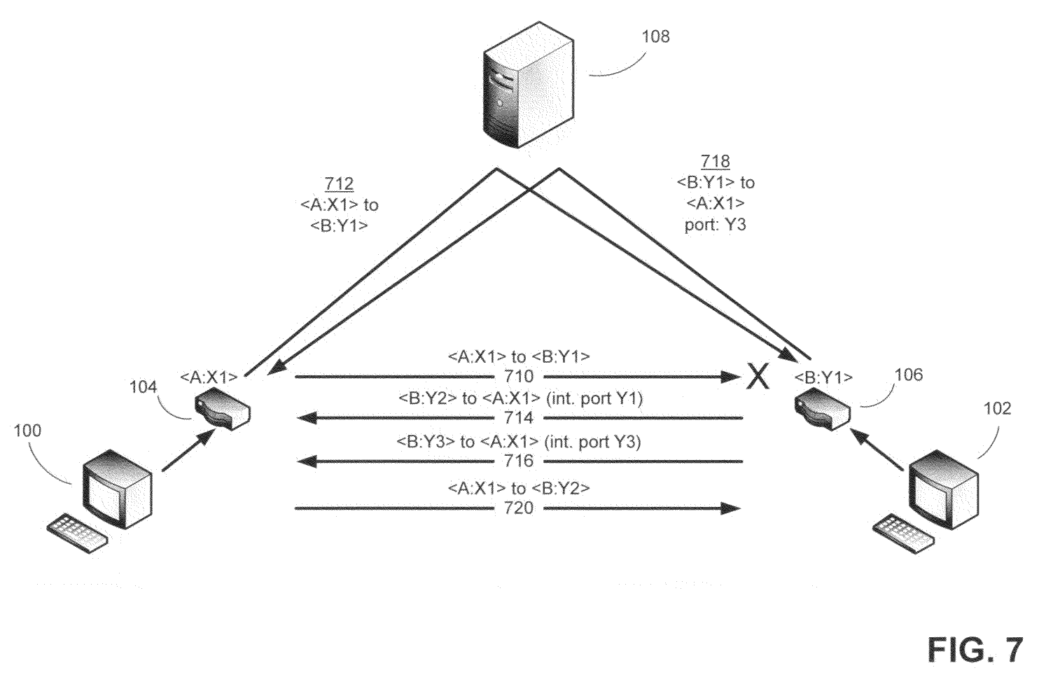

FIG. 7 shows an illustrative process for enabling communication between computing devices behind NATs in accordance with some embodiments of the invention. In this example, computing device 100 is behind an address-restricted NAT and computing device 102 is behind a port-preserving symmetric NAT.

In transmission 710, computing device 100 attempts to open a connection to computing device 102 with a packet transmitted from public address <A:X1> to address <B:Y1>, which is blocked as described above. This packet is transmitted from address <A:X1> because of the nature of NAT 104 as an address-restricted NAT. Detecting that the transmission of transmission 710 did not reach computing device 102, computing device 100 transmits a packet to computing device 102 through server 108 in transmission 712. This second packet is received by computing device 102 because the NAT 106 detects it as arriving from server 108. When computing device 102 processes the packet from server 108, it creates a new socket and binds it to a random private port (e.g., Y3).

In transmission 714, computing device 102 transmits a packet to computing device 100 which is sent out from public address <B:Y2> with address <A:X1> as the destination. As before, this packet is transmitted from internal/private port Y1. In contrast with earlier exemplary processes, however, because computing device 100 is behind an address-restricted NAT and has previously communicated with computing device 102 in transmission 710, the packet of transmission 414 is relayed by the NAT 104 and received by computing device 100. In embodiments of the invention, the process will recognize this acceptance and move on to transmission 720.

In alternate embodiments of the invention, however, the process will continue as if the packet were not accepted. In transmission 716, computing device 102 sends a second packet to computing device 100 from the new randomly-picked private port Y3. The packet of transmission 716 may also include an indicator of what private port it was transmitted from, to distinguish it from the packet of transmission 714. Because the NAT 106 is port-preserving, the packet is transmitted with a public address of address <B:Y3>. The second packet is sent to address <A:X1>, in accordance with the packet received from computing device 100 by way of server 108 in transmission 712. This packet is accepted and relayed by the NAT 104 because the computing device 100 previously communicated with computing device 102 in act 710, and because NAT 104 is an address-restricted NAT. This packet may not be accepted and/or processed by the computing device 100, however, as the computing device 100 may detect that a connection with computing device 102 was opened following transmission 714. In transmission 718, computing device 102 transmits an indirect packet to computing device 100 via server 108 containing an indicator that it is awaiting a connection at port Y3.

In transmission 720, computing device 100 responds to the accepted packet of transmission 714 by transmitting a packet from address <A:X1> to address <B:Y2>. Because computing device 102 had communicated to address <B:Y2> to address <A:X1> previously (in transmission 714), NAT 106 allows the packet from address <A:X1> to address <B:Y2>, and all subsequent packets on this connection, to pass through it to computing device 102.

In this manner, communication has been enabled between two computing devices behind a port-preserving symmetric NAT and an address-restricted NAT. As discussed above and as will be further discussed below, however, it should be appreciated that embodiments of the invention may transmit a greater or fewer number of packets based on, for example, the types of NATs the computing devices are behind. Additionally, it should be appreciated that in some embodiments of the invention a generic algorithm may be implemented to execute all transmissions regardless of network properties while in alternate embodiments of the invention a specific algorithm may be implemented to select the transmissions based on the network properties (e.g., type of NATs).

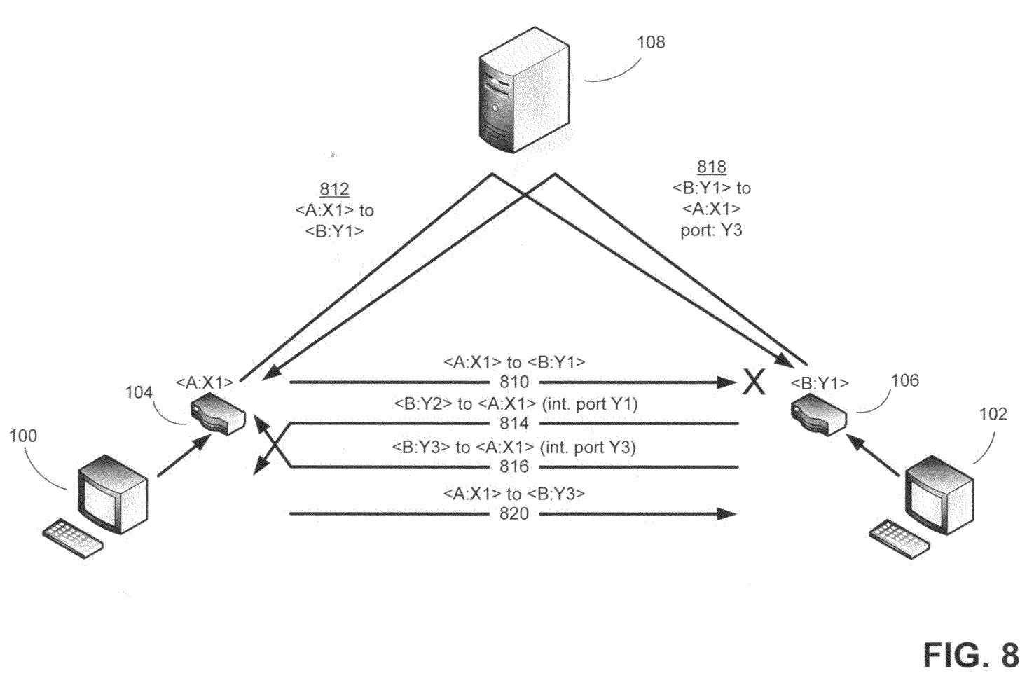

FIG. 8 shows a variant of the embodiment of the invention shown in FIG. 7, wherein the packets of transmissions 714 and 716 (814 and 816 in FIG. 8) are received by the NAT 104 in a different order than in which they were sent. This may be because of delays in the route one packet took through the network connecting NAT 104 and 106, because of packet data corruption that necessitated that the packet of 814 be resent, or because of any other condition that would lead packets to be received out of order.

As mentioned above, because NAT 104 is an address-restricted or full cone NAT in the embodiments of FIGS. 7 and 8, both the packets of 814 and 816 are relayed by the NAT 104 to computing device 100. Having received the packet of transmission 816 first, which was sent by NAT 106 from external address and port address <B:Y3>, in transmission 820 computing device 100 transmits a packet to computing device 102 from address <A:X1> to address <B:Y3>. This packet transmitted is accepted and relayed by NAT 106 because computing device 102 had previously communicated with computing device 100 to address <B:Y3> (in transmission 816).

In this manner, communication has been enabled between two computing devices behind a port-preserving symmetric NAT and an address-restricted NAT. As discussed above and as will be further discussed below, however, it should be appreciated that embodiments of the invention may transmit a greater or fewer number of packets based on, for example, the types of NATs the computing devices are behind. Additionally, it should be appreciated that in some embodiments of the invention a generic algorithm may be implemented to execute all transmissions regardless of network properties while in alternate embodiments of the invention a specific algorithm may be implemented to select the transmissions based on the network properties (e.g., type of NATs).

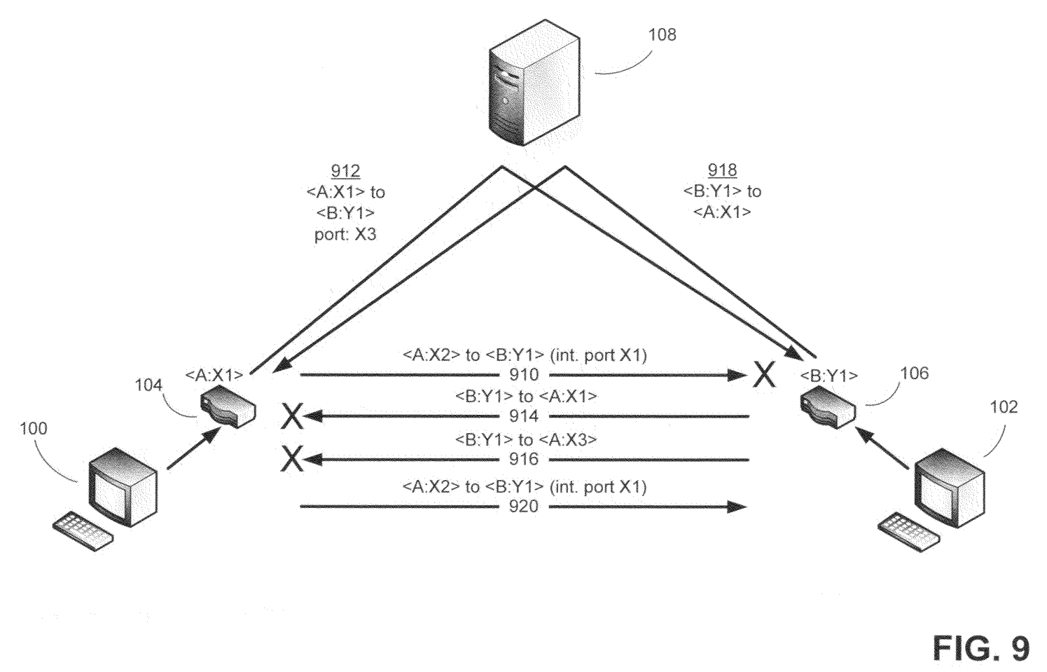

FIG. 9 shows an illustrative process for enabling communication between computing devices behind NATs in accordance with some embodiments of the invention. In this example, computing device 100 is behind a port-preserving symmetric NAT and computing device 102 is behind an address-restricted NAT.

In transmission 910, computing device 100 attempts to open a connection to computing device 102 with a packet transmitted from public address <A:X2> to address <B:Y1>, which is blocked as described above. This packet is transmitted from address <A:X2> because of the nature of NAT 104 as a symmetric NAT (computing device 100 already has a connection on public port X1 open to the Teredo server). Computing device 100 also opens a new socket locally on a random private port X3, but does not transmit any data over it yet. Detecting that the transmission of transmission 910 did not reach computing device 102, computing device 100 transmits a packet to computing device 102 through server 108 in transmission 912. This packet includes an indicator of the newly-opened socket on private port X3. This second packet is received by computing device 102 because the NAT 106 detects it as arriving from server 108.

When computing device 102 processes the packet from server 108, it transmits a packet (in transmission 914) to computing device 100 which is sent out from public address <B:Y1> with address <A:X1> as the destination. This packet is transmitted from internal/private port Y1 and external/public port Y1 because the NAT 106 is an address-restricted/cone NAT. This packet is blocked by the NAT 104 because the computing device 100 has not previously or recently communicated with computing device 102 via address <B:Y1> from address <A:X1>. In transmission 916, computing device 102 sends a second packet to computing device 100 to address <A:X3>, in accordance with the packet received from computing device 100 by way of server 108 in transmission 912. This packet is also blocked by the NAT 104, again because the computing device 100 has not previously or recently communicated with computing device 102 via address <B:Y1> from address <A:X3>. In transmission 918, computing device 102 transmits an indirect packet to computing device 100 via server 108 indicating that it is attempting to connect.

In transmission 920, computing device 100 responds to the accepted packet of transmission 918 by transmitting a packet from address <A:X2> to address <B:Y1>. Because computing device 102 had communicated over public address B to computing device 100 as A previously (in transmission 914), NAT 106 allows the packet from address <A:X2> to address <B:Y1>, and all subsequent packets on this connection, to pass through it to computing device 102.

In this manner, communication has been enabled between two computing devices behind a port-preserving symmetric NAT and an address-restricted NAT. As discussed above and as will be further discussed below, however, it should be appreciated that embodiments of the invention may transmit a greater or fewer number of packets based on, for example, the types of NATs the computing devices are behind. Additionally, it should be appreciated that in some embodiments of the invention a generic algorithm may be implemented to execute all transmissions regardless of network properties while in alternate embodiments of the invention a specific algorithm may be implemented to select the transmissions based on the network properties (e.g., type of NATs).

Various embodiments of the invention have now been described which make use of the port-preserving nature of symmetric NATs to communicate with computing devices behind other NATs. As should be apparent from the foregoing embodiments, the functionality of the specific NAT on each side of the connection is not relevant. Instead, it is only necessary that one of the NATs have port-preserving functionality.

It should be appreciated that the illustrative processes described in conjunction with FIGS. 4-9 are merely exemplary, and embodiments of the invention are not limited to carrying out the transmissions described therewith. It should also be appreciated that embodiments of the invention are not limited to performing a process outlined by any of the exemplary FIGS. 4-9. For example, as discussed above, it should be appreciated that embodiments of the invention may transmit a greater or fewer number of packets based on, for example, the types of NATs the computing devices are behind. Additionally, it should be appreciated that in some embodiments of the invention a generic algorithm may be implemented to execute all transmissions regardless of network properties while in alternate embodiments of the invention a specific algorithm may be implemented to select the transmissions based on the network properties (e.g., type of NATs).

It should be further appreciated that embodiments of the invention may execute fewer or more transmissions based on having more or less information. For example, in FIG. 4, if computing devices 100 and 102 were aware that each was behind a NAT that would block the packets transmitted in transmissions 410 and 414 (a symmetric NAT, for example), they may not transmit those packets. Instead, computing devices 100 and 102 may omit transmissions 410 and 414 and transmit the packets of transmissions 412 and 416 first. Computing devices 100 and 102 may be provided with information about the other computing device's NAT by, for example, server 108 after the NAT type is determined as discussed above. It should also be appreciated that transmissions 510, 514, 610, 614, 710, 714, 810, 814, 910, and 914, as shown in FIGS. 5-9, may be omitted for similar reasons as act 410 and 414. Alternatively, as described above, if, in the embodiment of FIG. 7, computing device 102 were aware that the packet transmitted in transmission 714 would be accepted and relayed by the NAT 104, it may not transmit the remainder of the packets (716, 718, and 720). Again, it should be appreciated that the corresponding transmissions of FIGS. 4-6 and 8-9 (i.e., 416, 418, 420, 422, 516, 518, 520, 522, 616, 618, 620, 622, 816, 818, 820, 916, 918, 920) may similarly be omitted based on, for example, knowledge of the acceptance of a packet by the NAT 104.

Further, in embodiments of the invention, computing device 100 may open a connection to computing device 102 over the secondary port created during the connection process (e.g., X3 or Y3) even if the connection over the primary port (e.g., X1 or Y1) has been established. For example, in FIG. 9, computing device 100 has opened a connection with computing device 102 from address <A:X2> (internal port X1) to address <B:Y1> in transmission 920. Computing device 100 may then open a second connection to computing device 102 over the secondary port (i.e., from address <A:X3> to address <B:Y1>) with a transmission 922. This also applies to transmissions 722 and 822 of FIGS. 7-8. Once the connection with the secondary port is open, the connection may be closed. Alternatively, the socket can be left open to be closed later by a periodic timer cleanup routine. For example, a socket that is open with a private port that has not received a packet for 10 minutes or any other suitable length of time may be closed by a cleanup routine. This may be done to ensure that no sockets are being closed improperly.

To prevent attacks on systems implementing embodiments of the invention, the number of sockets that may be used to establish connections with computing devices behind NATs may be limited. This limit may be set at any number to prevent system resources from being depleted while still keeping low the chance of valid connections being denied connections (e.g., 200). This limit may be imposed on only some connections. For example, the number of connections to computing devices behind port-preserving symmetric NATs may be limited, while connections to address-restricted or cone NATs may not.

Once the limit has been reached, embodiments of the invention may take actions to limit further the chances that a valid user is denied a connection. In some embodiments, this may be done by “reclaiming” used sockets. While the sockets may be reclaimed by the cleanup routine mentioned above once the pre-established timeout period has elapsed, sockets may be reclaimed if they are not being used and more connections are requested. For example, if the limit on the number of sockets for connections is reached, when a request for a new connection is received, a “least recently used” (LRU) model may be used to reclaim sockets before the connection request is held idle or refused. An exemplary LRU model that may be implemented by embodiments of the invention ranks the sockets by time from last communication and if a socket has not received any data for over a pre-established time period (e.g., 30 seconds), that socket may be reclaimed and used for the new connection.

Once a connection is established, embodiments of the invention may also take steps to prevent the NATs from erasing information about the connection (e.g., port mapping information). As mentioned above, for a packet to be relayed from the NAT to its intended recipient, the recipient must have communicated to the transmitter previously and recently. For example, a NAT may delete connection information after 60 seconds, and once that period has elapsed, data sent from the transmitter to the receiver behind the NAT may be blocked by the NAT. If this happens, the connection may have to be reopened, such as by the processes described above. To prevent this, embodiments of the invention may send empty or meaningless “bubble packets” across the connection if no data has been recently sent (“recently” may be defined in any suitable manner but may mean, for example, within the last 30 seconds). These bubble packets then maintain the connection information in the NAT. Embodiments of the invention may keep transmitting bubble packets until the connection is closed, and alternative embodiments of the invention may put a limit on the number of bubble packets that are transmitted to guard against flooding a network with bubble packets. For example, in one embodiment of the invention a computing device may send 10 bubble packets, one each time the connection is determined to have not transmitted data “recently,” and then allow the connection information to be deleted. Once deleted, the connection may be re-established in any manner, including using the exemplary processes described above.

The aspects of the present invention described herein can be implemented on any of numerous computer system configurations and are not limited to any particular type of configuration. A general-purpose computing system is now described, on which embodiments of the invention may be implemented.

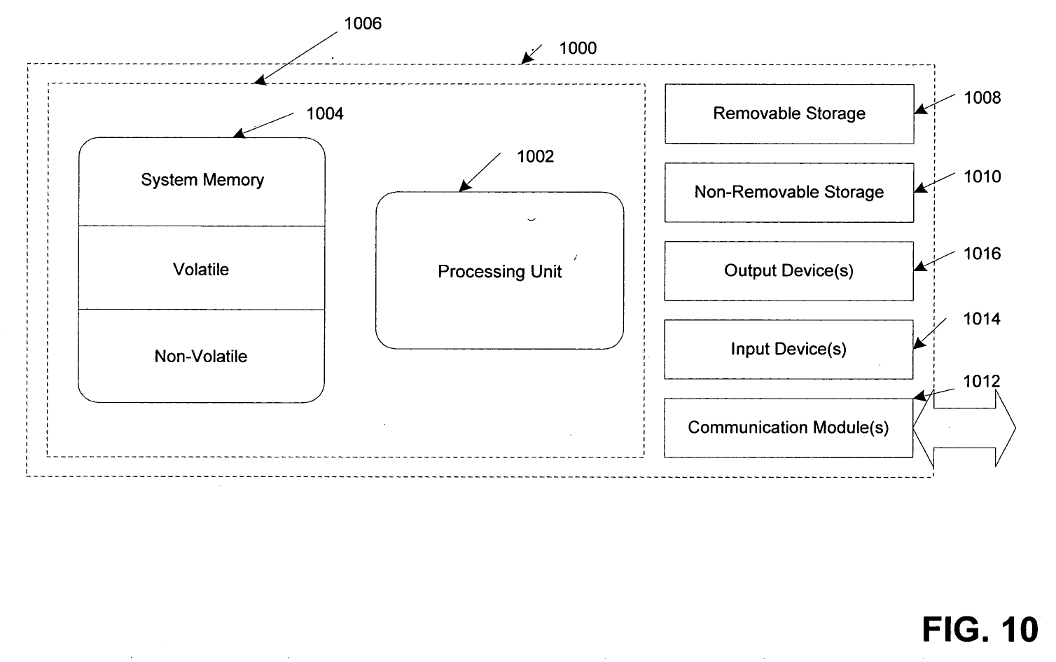

With reference to FIG. 10, an exemplary system for implementing embodiments of the invention includes a computing device, such as computing device 1000, which may be a device suitable to function as a node of network environment (e.g., server, desktop/laptop personal computer, personal digital assistant (PDA), smart phone, etc.). Computing device 1000 may include at least one processing unit 1002 and memory 1004. Depending on the exact configuration and type of computing device, memory 1004 may be volatile (such as RAM), non-volatile (such as ROM, flash memory, etc.) or some combination of the two. This most basic configuration is illustrated in FIG. 10 by dashed line 1006. Additionally, device 1000 may also have additional features/functionality. Memory 1004 is a form of computer-readable media that may store instructions, having wireless medium parameters for various nodes in network environment.

Device 1000 may include at least some form of computer readable media. Computer-readable media can be any available media that can be accessed by device 1000. By way of example, and not limitation, computer readable media may comprise computer storage media and communication media. For example, device 1000 may also include additional storage (removable and/or non-removable) including, but not limited to, magnetic or optical disks or tape. Such additional storage is illustrated in FIG. 10 by removable storage 1008 and non-removable storage 1010. Computer storage media includes volatile and nonvolatile, removable and non-removable media implemented in any method or technology for storage of information such as computer readable instructions, data structures, program modules or other data. Memory 1004, removable storage 1008 and non-removable storage 1010 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 1000. Any such computer storage media may be part of device 1000.

Device 1000 may also contain communications module(s) 1012 that allow the device to communicate with other devices. Communications module(s) 1012 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer-readable media as used herein includes both storage media and communication media.

Device 1000 may also have input device(s) 1014 such as keyboard, mouse, pen, voice input device, touch input device, etc. Output device(s) 1016 such as a display, speakers, printer, etc. may also be included. All these devices are well know in the art and need not be discussed at length here.

It should be appreciated that the invention is not limited to executing on any particular system or group of systems. For example, embodiments of the invention may run on one device or on a combination of devices. Also, it should be appreciated that the invention is not limited to any particular architecture or network.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface including keyboards, and pointing devices, such as mice, touch pads, and digitizing tables. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or methods outlined herein may be coded as software that is executable on one or more processors that employ any one of a variety of operating systems or platforms. Additionally, such software may be written using any of a number of suitable programming languages and/or conventional programming or scripting tools, and also may be compiled as executable machine language code or intermediate code that is executed on a framework or virtual machine.

In this respect, the invention may be embodied as a computer-readable medium (or multiple computer-readable media) (e.g., a computer memory, one or more floppy discs, compact discs, optical discs, magnetic tapes, flash memories, circuit configurations in Field Programmable Gate Arrays or other semiconductor devices, etc.) encoded with one or more programs that, when executed on one or more computers or other processors, perform methods that implement the various embodiments of the invention discussed above. The computer-readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method for communicating between first and second computing devices wherein each computing device is behind a Network Address Translator (NAT), the method comprising:
(A) transmitting a first communication from the first computing device to a third computing device adapted to relay communications from the first computing device to the second computing device, the first communication comprising an indicator of a port number on the first computing device over which the first and second computing devices are to communicate, wherein the third computing device has an existing connection to both the first computing device and the second computing device; and
(B) transmitting a second communication from the first computing device to the second computing device to open a connection, wherein an originating address of the second communication has a port number equivalent to the port number contained in the indicator.

2. The method of claim 1, further comprising:
(C) opening a socket on the first computing device, wherein a port number of the socket matches the port number contained in the indicator.

3. The method of claim 1, wherein the first and second computing devices are Teredo clients and the third computing device is a Teredo server.

4. The method of claim 1, further comprising:
(C) receiving, at the first computing device from the second computing device, a second indicator of a second port number of the second computing device over which the first and second computing devices are to communicate.

5. The method of claim 4, wherein a destination address of the second communication has a port number equivalent to the second port number of the second indicator.

6. The method of claim 4, wherein (C) comprises:
(C1) receiving the second indicator from a third computing device adapted to relay the second indicator to the first computing device.

7. A method for communicating between first and second computing devices wherein each computing device is behind a Network Address Translator (NAT), the method comprising:
(A) receiving a first communication at the second computing device from a third computing device adapted to relay communications from the first computing device to the second computing device, the first communication comprising an indicator of a port number on the first computing device over which the first and second computing devices are to communicate, wherein the third computing device has an existing connection to both the first and second computing devices;
(B) transmitting, from the second computing device to the first computing device, a second communication, wherein a destination address of the second communication has a port number equivalent to the port number contained in the indicator; and
(C) receiving, at the second computing device from the first computing device, a third communication to open a connection, wherein an originating address of the third communication has a port number equivalent to the port number contained in the indicator.

8. The method of claim 7, wherein the first and second computing devices are Teredo clients and the third computing device is a Teredo server.

9. The method of claim 7, further comprising:
(D) transmitting, to the first computing device from the second computing device, a second indicator of a second port number of the second computing device over which the first and second computing devices should communicate.

10. The method of claim 9, wherein a destination address of the third communication has a port number equivalent to the second port number of the second indicator.

11. The method of claim 9, wherein (D) comprises:
(D1) transmitting the second indicator to a third computing device adapted to relay the second indicator to the first computing device.

12. The method of claim 9, further comprising:
(E) opening a socket on the second computing device, wherein a port number of the socket matches the second port number contained in the second indicator.

13. The method of claim 7, further comprising:
(D) communicating with the third computing device to determine what type of NAT the first computing device is behind.
wherein the act (D) is executed prior to the act (A).

14. A computer apparatus comprising at least one computer-readable medium, the computer-readable medium having computer-executable instructions encoded thereon which, when executed, cause the computer apparatus to execute a method for communicating between first and second computing devices wherein each computing device is behind a Network Address Translator (NAT), the method comprising:
(A) transmitting a first communication from the first computing device to a third computing device adapted to relay communications from the first computing device to the second computing device, the first communication comprising an indicator of a port number on the first computing device over which the first and second computing devices are to communicate, wherein the third computing device has an existing connection to both the first computing device and the second computing device; and
(B) transmitting a second communication from the first computing device to the second computing device to open a connection, wherein an originating address of the second communication has a port number equivalent to the port number contained in the indicator.

15. The computer apparatus of claim 14, further comprising:
(C) opening a socket on the first computing device, wherein a port number of the socket matches the port number contained in the indicator.

16. The computer apparatus of claim 14, wherein the first and second computing devices are Teredo clients and the third computing device is a Teredo server.

17. The computer apparatus of claim 14, further comprising:
(C) communicating with the third computing device to determine what type of NAT the first computing device is behind.
wherein the act (C) is executed prior to the act (A).

18. The computer apparatus of claim 15, further comprising:
(C) receiving, at the first computing device from the second computing device, a second indicator of a second port number of the second computing device over which the first and second computing devices are to communicate.

19. The method of claim 18, wherein a destination address of the second communication has a port number equivalent to the second port number of the second indicator

20. The computer apparatus of claim 18, wherein (C) comprises:
(C1) receiving the second indicator from a third computing device adapted to relay the second indicator to the first computing device.
